(19) United States
(12) Patent Application Publication
(10) Pub. No.: US 2017/0064401 A1
(43) Pub. Date: Mar. 2, 2017

(54) ORDERING AN ITEM FROM A TELEVISION

(71) Applicant: NCR Corporation, Duluth, GA (US)

(72) Inventor: Jinhyun Kim, San Jose, CA (US)

(21) Appl. No.: 14/838,670

(22) Filed: Aug. 28, 2015

(51) Int. Cl. H04N 21/478; H04N 21/239; H04N 21/858; H04N 21/4782; H04N 21/81; H04N 21/236; H04N 21/4725

(52) U.S. Cl. CPC H04N 21/47815; H04N 21/23614; H04N 21/2393; H04N 21/4725; H04N 21/4782; H04N 21/812; H04N 21/8133; H04N 21/8586

(57) ABSTRACT

Systems and methods for ordering an item from a television may include receiving, at a computing device comprising a processor, broadcast content to be displayed on a television and information associated with an item. The item may be displayed when the broadcast content is displayed on the television. The systems and methods may also include creating a composite signal that may include both the broadcast content and the information associated with the item. The composite signal may be transmitted to the television. Furthermore, an information request for the item may be received at the computing device.

### BACKGROUND

People watch a lot of television. By some estimates people spend as many as five hours or more watching television per day, or 35 or more hours per week. Product placement, and companies vying to have their products placed, in television programming is increasing. In addition, programmers are starting to edit television programs to make more room for commercials. For example, portions of a television program may be removed and closing credits for one program may run while an opening scene or credits for another program run in order to shorten the programs and allow more time for commercials to air.

### SUMMARY

Systems and methods for ordering an item from a television may include receiving, at a computing device comprising a processor, broadcast content to be displayed on a television and information associated with an item. The item may be displayed when the broadcast content is displayed on the television. The systems and methods may also include creating a composite signal that may include both the broadcast content and the information associated with the item. The composite signal may be transmitted to the television or a digital media set-top box. Furthermore, an information request for the item may be received at the computing device.

### BRIEF DESCRIPTION OF THE FIGURES

The above-mentioned and other features and advantages of embodiments disclosed herein, and the manner of attaining them, will become more apparent and the disclosure itself will be better understood by reference to the following description of example embodiments taken in conjunction with the accompanying drawings, wherein:

FIG. 1 shows an operating environment for ordering an item from a television consistent with embodiments disclosed herein;

FIG. 2 shows an example schematic of a television or computing device consistent with embodiments disclosed herein;

FIG. 3 shows an example flowchart for a method for ordering an item from a television consistent with embodiments disclosed herein.

Corresponding reference characters indicate corresponding parts throughout the several views. The examples set out herein illustrate example embodiments, and such examples are not to be construed as limiting the scope of the disclosure any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

As people watch more and more television, the desire to place information about products and services into the content displayed on television may increase. The increase in product placement can lead to increase sales. In addition, allowing a viewer to order products and services directly from his or her television can also lead to increased sales.

Today's televisions have increasing capabilities that can allow viewers to purchase items seen on television. For example, televisions today can include web browsers, dedicated processors and memory that stores instructions that can allow the television to do more than just display television programming. For example, televisions can include web browsers that allow users to browse the Internet, play videos from websites such as YouTube®, and much more.

With the increased capabilities of televisions, the ability for viewers to order products seen on television increases. Television content, such as television shows and movies, as well as commercials, can include information about products and services displayed on television. The information can be used to facilitate ordering the products and services directly from the television at the time the viewer sees the products and services.

For example, while watching a television commercial a viewer may be able to click a link provided in the commercial. The link may activate a web browser on the television and the viewer can directly order the product from the advertiser's website. For example, during a pizza commercial the viewer may be able to click a link to the pizza retailer's website and order the advertised pizza.

In addition, a viewer may see a product within a television show or movie. Using features of the television, the viewer may tag the product. The tagging may allow the viewer to submit a web query to determine more information about the product. For example, a viewer may see a celebrity wearing a particular watch on a television program. The viewer may like the watch and may want to know more about where the watch can be purchased. As such, the user may be able to tag the watch using his or her television remote and submit the tag as a query. The query could be sent to the broadcast source, search engines such as GOOGLE®, or commerce websites such as AMAZON®. The query may return information from retailers or the manufacturer about the watch such as, costs, local retailers, and such.

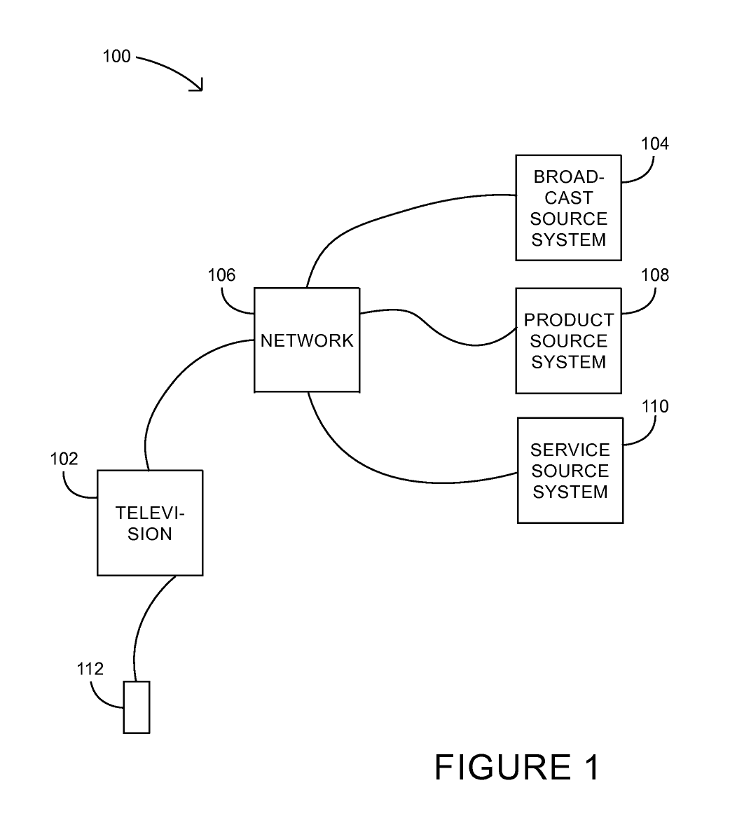

FIG. 1 shows an operating environment 100 for ordering products and services from a television 102. The television 102 can receive composite signals from a broadcast source system 104 via a network 106. The composite signal can be supplemented with product information from a product source system 108 and service information from a service source system 110 via the network 106.

The broadcast source system 104 can be any television provider that provides programming or the content to be displayed on the television 102. The programming or content may or may not be regularly scheduled. For example, the content could be an on-demand content that is streamed on the television 102. In addition, the broadcast source system 104 could be network television that is broadcasting as regularly scheduled programming. Non-limiting examples of broadcast source system 104 include over the air satellite, cable, and IP-TV. In addition, a digital video recorder (DVR) that has recorded content can be a broadcast source. For example, a cable provider may access the contents of a user's DVR and add supplement content based on programs the user has saved.

The product source system 108 may provide the product information to the broadcast source system 104 directly. The broadcast source system 104 may combine the product information with the composite signal and distribute the information to the television 102. For example, an advertiser may purchase a time slot for a commercial to air. The advertiser may send the commercial to the operator of the broadcast source system 104 that may splice the commercial into a composite signal so that the commercial is aired at the appropriate time.

The product information provided by the product source system 108 can also be provided after a broadcast is received at the television 102. For example, a viewer may be watching television and notice a product the viewer likes. The viewer may tag the product, such as by pressing a button on a remote 112, which may be a remote controller or a mobile device (e.g., smartphone, tablet, smartwatch) paired to television 102. The television 102 may transmit, via the network 106, a request for the product information to the broadcast source system 104 or the product source system 108 requesting the product information. In addition, the broadcast source system 104 may transmit the request for the product information to the product source system 108.

Similar to the product source system 108, the service source system 110 may provide the service information to the broadcast source system 104 directly. The broadcast source system 104 may combine the service information with the composite signal and distribute the information to the television 102. For example, an advertiser may purchase a time slot for a commercial to air. The advertiser may send the commercial to the operator of the broadcast source system 104 that may splice the commercial into a composite signal so that the commercial is aired at the appropriate time.

While FIG. 1 illustrates the product source system 108 and the service source system 110 as separate entities, the product source system 108 and the service source system 110 can be a common entity. For example, a marketing or advertising agency may product and service information simultaneously via a combined product source system 108 and a service source system 110.

The service information provided by the service source system 110 can also be provided after a broadcast is received at the television 102. For example, a viewer may be watching television and notice a service the viewer would like performed. The viewer may click a link provided in the commercial, such as by pressing a button on the remote 112. The television 102 may transmit, via the network 106, a request for the service information to the broadcast source system 104 or the service source system 110 requesting the service information. In addition, the broadcast source system 104 may transmit the request for the product information to the service source system 110.

The product or service information may be returned to the television 102 in the form of a webpage maintained by the product or service provider that may contain the product information. In addition, the product and service information may be the results of a web query, such as an Internet search performed using a search engine such as GOOGLE® or BING®. The product or service information may be with regard to a specific product or service tagged by the viewer, a product or service information associated with a specific advertisement or program segment, a listing of all products or services associated with an entire program, which may also include all advertisements associated with the program, and the like.

The product and service information may include, but is not limited to, a product number for an item displayed on the television 102, a manufacturer name for the item, and a model number for the item. In addition, the product or service information may be a link to a webpage containing additional information about the product or service. The webpage may be operated by a manufacturer of the item or a supplier of the service. In addition, the webpage may be operated by a third-party such as AMAZON®.

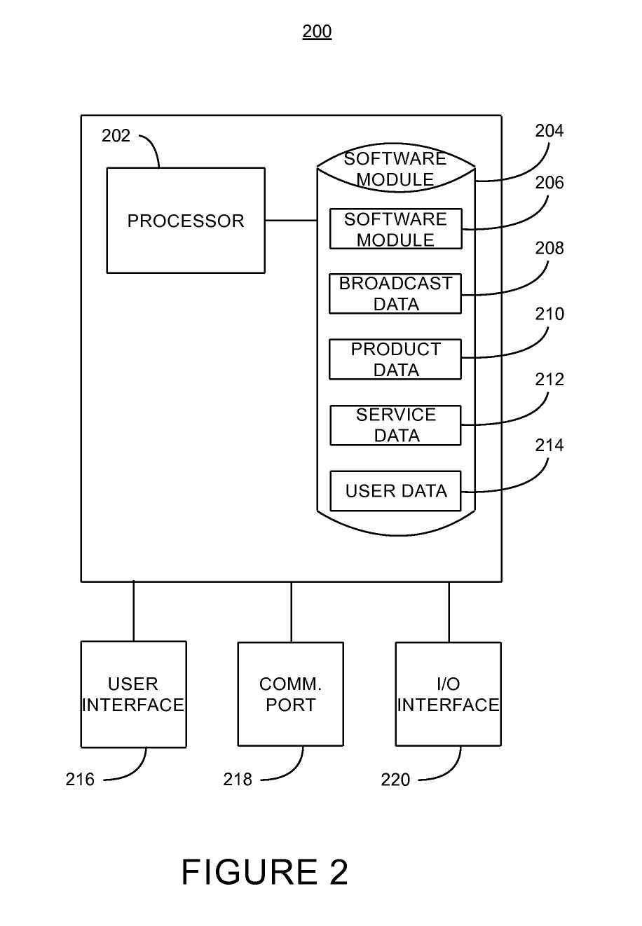

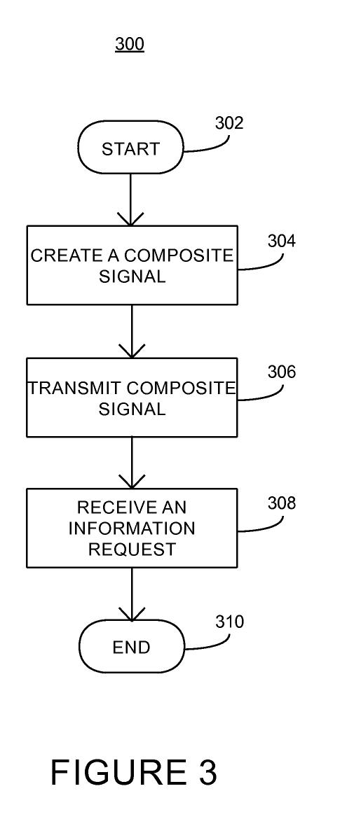

FIG. 2 shows an example schematic of a computing device 200. As shown in FIG. 2, the computing device 200 may include a processor 202 and a memory unit 204. The memory unit 204 may include a software module 206, broadcast data 208, product data 210, service data 212, and user data 214. While executing on the processor 202, the software module 204 may perform processes for ordering a product or service from the television 102, including, for example, one or more stages included in method 300 described below with respect to FIG. 3.

The broadcast data 208 can include content to be displayed on the television 102. For example, the broadcast data 208 may include programming, such as television shows, movies, sporting events, and such, to the displayed on the television 102. In addition, the broadcast data 208 can include commercials that can be displayed during the regularly scheduled programming.

The product data 210 can include information about an item to be displayed on the television 102. For example, the product data 210 may include, but is not limited to, a product name, a product manufacturer, a model name, a link to a website where the item can be purchased, a link to a manufacturer of the product's website, a cost of the item, and such. The product data 210 may also include an advertisement for the item. For instance, the product data 210 may include a commercial prepared by an advertiser or manufacturer of the product. Note that throughout this disclosure the terms product and item may be used interchangeably to refer to chattels displayed on the television 102.

The service data 212 can include information about a service displayed on the television 102. For example, the service data 212 may include, but is not limited to, a service name, a service provider, a link to a website where the service can be purchased, a cost of the service, and such. The service data 212 may also include an advertisement for the service. For instance, the service data 212 may include a commercial prepared by an advertiser or provider of the service.

The user data 214 can include information about a user of the television 102. For example, the user data 214 may include, but is not limited to, credit card or other payment information that may be used to pay for items purchased via the television 102, a billing address, a shipping address, loyalty program data, customer account data, user preferences, shopping history, browser history, and such. In addition, the user data 214 could be augmented with data from third parties. For example, a user may link to third-party accounts, such as FACEBOOK®, and information from a user's FACEBOOK® profile, including information the user has “liked” can be used to augment the user data 214. The user data 214 may be input by the user or may be obtained from the broadcast source system 104. For example, the user data 214 may include billing information that may be obtained from a cable, satellite, Internet, streaming service provider, and third-party digital wallet services, such as PAYPAL®, GOOGLE® Wallet, and APPLE® Pay.

In addition, the user data 214 may include viewing history and purchasing history of the viewer. The user data 214 can also include preferences or other controls for viewer. For example, the user data 214 may include parental controls that prohibit children from making purchases, restrict purchases to items and services that cost below a preset amount, or restrict total purchases for a time period to a preset spending limit.

In addition, the user data 214 can include profiles for multiple users. For example, the user data 214 may contain a user profile for each adult and child that may typically use the television 102. Each profile can contain the various user information described herein. In addition, to the various user profiles for individual users, the user data 214 can include a general user profile. The general user profile may contain information common to all users, such as, but not limited to, payment information, billing and shipping addresses, etc. The user data 214 may be used by the broadcast source system 104, the product source system 108, and the service source system 110 to customize advertisement and other product and service offerings that may be displayed on the television 102.

The computing device 200 may also include a user interface 216. The user interface 216 can include any number of devices that allow a user to interface with the computing device 216. Non-limiting examples of the user interface 216 include a keypad, a microphone, a display (touchscreen or otherwise), etc.

The computing device 200 may also include a communications port 218. The communications port 218 may allow the computing device 200 to communicate with various information sources, such as, but not limited to, the broadcast source system 104, the product source system 108, and the service provider source 110, described above with regard to FIG. 1. Non-limiting examples of the communications port 218 include, Ethernet cards (wireless or wired), Bluetooth® transmitters and receivers, near-field communications modules, cable or satellite set top boxes, an APPLE® TV device, ROKU®, etc.

The computing device 200 may also include an input/output (I/O) device 220. The I/O device 220 may allow the computing device 200 to receive and output information. For example, the I/O device 220 may include a camera that can capture an image of the viewer. Using the captured image, the processor 202 may identify the viewer and load a user profile associated with the viewer. Non-limiting examples of the I/O device 220 include, a camera (still or video), a printer, a scanner, etc.

The computing device 200 may be a component of the television 102, the broadcast source system 104, the product source system 108, or the service source system 110. The computing device 200 may be implemented using a personal computer, a network computer, a mainframe, a handheld device, a personal digital assistant, a smartphone, a smart TV, or any other similar microcomputer-based workstation. The computing device 200 also can be a set top box, as integrated with the television 102. In addition, the computing device 200 also can be a projector, such as a computer that can be coupled to a display such as the television 102, an LCD panel, and the like.

FIG. 3 shows a flowchart of an example method 300 for ordering a product or service via a television, such as the television 102. The method 300 may begin at stage 302 and proceed to stage 304 where a composite signal may be created by the computing device 200. In creating the composite signal, the computing device 200 may receive broadcast content that may be displayed on the television 102. For example, as described herein, the broadcast content may be received from the broadcast source system 104. In addition, the computing device 200 may receive information about an item or product embedded in the broadcast content that is to be displayed on the television 102. The broadcast content can include a television program such as, but not limited to, a television show, a movie, a news program, and a sporting event. The broadcast content can also include a television commercial that airs during a television show, a movie, or a sporting event. In addition, the broadcast content can include an infomercial.

The information about the item can include a tag embedded into the composite signal that identifies the item. For example, the composite signal could include metadata that identifies various items located in a television show, in a particular scene, in a particular frame or series of frames, and the like. The items could be items that an advertiser or manufacture has paid to have placed in the broadcast as part of a product placement or an advertising campaign. The tag may include a product name for the item, a product number for the item, a manufacturer name for the item, and a model number for the item. In addition, the tag may include a Uniform Resource Locator (URL) or a compressed (URL). The URL, when selected by the viewer, may launch an application, such as a web browser, on the television 102, that can allow the viewer to view the product information.

From stage 304, method 300 may proceed to stage 306 where the composite signal may be transmitted to the television 102. The transmission of the composite signal may be part of a regularly scheduled broadcast. In addition, the transmission of the composite signal may be part of an on-demand or streaming broadcast where the viewer of the television requested the composite signal be sent to the television 102.

During transmission of the composite signal the viewer may see various items that are depicted on the television 102 as part of the broadcast. The user may request information about any of the various items. To request the information the user may press a button on the remote 112. The television may then send a signal to the computing device 200. The signal may include a request for the information. The request for the information may be return a link to a website that may allow the user to learn more about the item and to purchase the item. The link to the website may be received at the television 102 during the broadcast of the broadcast content. Also, while requesting the information the playback of the broadcast content on the television 102 may be paused or a size of the picture may be altered such that the information received at the television 102 does not obstruct the display of the broadcast content. The user may select the link via the remote 112 to cause the website to be displayed.

Items or products do not have to be tagged in order for the viewer to request information about an item or product. For example, a viewer may be watching a movie and see a character wearing a watch the viewer likes. The composite signal may not include any tags for the watch. In this instance, the viewer may provide an input using the remote 112. The input may cause the television 102 to create a screen capture of the broadcast content being displayed. The user may use the remote to tag the watch or other items being displayed.

The screen capture and any tags the viewer may have placed in the screen capture may be sent from the television 102 to the computing device 200. The computing device may extract information about the item from the screen capture that may be used to find information about the item. For example, the computing device 200 may perform an image analysis of the screen capture to determine information about the item. The image analysis may include comparing the item in the screen capture to a database of images of items. The tag by the user may assist in the image analysis. For example, the user may indicate that the image is of a watch. As a result, the computing device may access websites of watch manufacturers or databases of watch information.

In addition, a screen capture can be a capture of metadata that can identify a time or frame within the program. The metadata can be used by the computing device 200 to retrieve the frame. The computing device 200 can then perform the image analysis on the image. Furthermore, products present in the frame at that the time may be known and cataloged in a database. Use of the time or frame metadata could allow the computing device to retrieve a listing of the products in the frame for display on the television 102. The metadata could also include closed captioning text that may provide information to identify products or services.

In addition, the image analysis may include performing an object character recognition (OCR) of the screen capture to determine if there is any text in the image that could be informative of the item. For example, the OCR process may lead to a manufacturer's name that is on the item. In addition, closed captioning text can be OCR to obtain information about products in the frame or image. The computing device 200 may use the manufacturer's name to retrieve images of watches made by the manufacture that can be used for the image analysis. In addition, the computing device 200 may search the manufacturer's website and transmit to the television 102 search results of various watches made by the manufacturer. In addition, the OCR process result in a model number or other information being retrieved and sent to the television 102 by the computing deice 200. In addition to the manufacturer's website, a third party website, such as AMAZON®, could be searched for information regarding the watch. Furthermore, information for similar items could be returned to the television 102. For instance, similar watches from different manufacturers that are similar in style and price as the watch in the screen capture could be returned to the television 102 from the third party website.

From stage 306, method 300 may proceed to stage 208 where the computing device may receive an information request for the item. As described herein, the information request may include a request for costs, expected availability, the manufacturer, etc. In addition, a purchase request can be received. The purchase request may include billing and shipping information stored in the user profile. From stage 308 method 300 may terminate at stage 310.

While method 300 has been described with regards to a watch, other items may be identified and present within a composite signal. For example, during a cooking show, various cooking products may be identified and presented to the viewer. The cooking products may be the pots, pans, and other tools used to prepare the food, the various ingredients may also be identified. The information within the composite signal may include a recipe for the dish being prepared. In addition, links to local supermarkets or other suppliers of the ingredients may be included.

In addition to products, services can be identified. For example, during a commercial a service supplier may include a link to its website and the link may be executable. Thus, the viewer may be able to click the link using the remote 112 and visit the supplier's website.

Furthermore, method 300 may be performed by the television 102, the broadcast source system 104, the product source system 108, the service source system 110, or any combination thereof.

For example, the television 102 may receive a composite signal that may include content depicting an item embedded within the content. The television 102 may receive an input from a viewer, via the remote 112. The input may include information to usable to purchase the item. The television may also transmit an order for the item. The order may include the information usable to purchase the item.

The television 102 may display links that the viewer may click using the remote 112 and may display webpages for items associated with the links. The television 102 may receive inputs that cause the television 102 to perform a screen capture. The television 102 may perform the image analysis of the screen capture. In addition, the television 102 may receive tags associated with items in the screen capture.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method comprising:
accessing stored content on a digital video recorder (DVR), the stored content saved by a user;
creating, at the DVR, a composite signal including both the stored content and information associated with an item to be displayed with the stored content;
transmitting, by the DVR, the composite signal to a television; and
receiving, at the DVR, an information request for the item from the television, the information request including a request for a cost and expected availability for the item at a local retailer that supplies the item.

2. The method of claim 1, further comprising:
receiving the stored content to be displayed on the television; and
receiving the information associated with the item.

3. The method of claim 1, wherein the composite signal includes a television program.

4. The method of claim 1, wherein the composite signal includes a television commercial.

5. The method of claim 1, wherein the information associated with the item includes a tag identifying the item.

6. The method of claim 5, wherein the tag includes a product name for the item, a product number for the item, a manufacturer name for the item, and a model number for the item.

7. The method of claim 1, further comprising receiving an input from the television, the input requesting the information associated with the item.

8. The method of claim 7, wherein the information associated with the item includes a link to a website to purchase the item.

9. The method of claim 8, wherein receiving the input from the viewer includes selection of the link.

10. The method of claim 7, wherein receiving the input from a viewer includes:
receiving a screen capture including an image of the item; and
extracting the information associated with an item from the screen capture.

11. The method of claim 10, wherein extracting the information from the screen capture includes performing an image analysis of the screen capture to determine the information associated with the item.

12. The method of claim 11, further comprising transmitting, the television, at least one of a product number for the item and a manufacturer name for the item determined via the image analysis.

13. The method of claim 11, further comprising:
transmitting a query to a commerce website, the query including the product number and the manufacturer name for the item for the item determined via the image analysis; and
transmitting results from the query to the commerce website to the television.

14. A system comprising:
a processor; and
a memory that stores instructions that, when executed by the processor, cause the processor to perform operations comprising:
accessing content stored within the memory by the user,
creating a composite signal including both a stored content and information associated with an item featured within the stored content,
transmitting the composite signal to a television, and
receiving an information request for the item, the information request including a request for a cost and expected availability for the item from a local retailer that supplies the item.

15. The system of claim 14, wherein the operations further comprise:
receiving the content to be displayed on a television, and
receiving information associated with the item, the item to be displayed when the content is displayed on the television.

16. The system of claim 14, wherein the information associated with the item includes a tag identifying the item, and wherein the tag includes a product name for the item, a product number for the item, a manufacturer name for the item, and a model number for the item.

17. The system of claim 16, wherein the operations further comprise receiving an input from the television, the input requesting the information associated with the item, wherein receiving the input from a viewer includes:
receiving a screen capture including an image of the item; and
extracting the information associated with an item from the screen capture, wherein extracting the information from the screen capture includes performing an image analysis of the screen capture to determine the information associated with the item.

18. A method comprising:
receiving, at a television comprising a processor, a composite signal including content depicting an item embedded within the content;
receiving, at the television, an input from a viewer, an input containing information to request additional information about the item; and
transmitting, by the television, a request for the additional information about the item, the additional information about the item including a cost and expected availability for the item from a local retailer that supplies the item.

19. The method of claim 18, further comprising displaying a website of the local retailer where the item can be purchased on the television.

20. The method of claim 18, further comprising transmitting a query to a commerce website of the local retailer, the query including a product number for the item, a manufacturer name for the item, and an image of the item, the image of the item captured by the television.
